(19) United States
(12) Patent Application Publication
(10) Pub. No.: US 2002/0195453 A1
(43) Pub. Date: Dec. 26, 2002

(54) Fuel tanks and fuel transport lines

(76) Inventor: David G. McLeod, Rochester, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/138,056

(22) Filed: May 2, 2002

Related U.S. Application Data
(60) Provisional application No. 60/288,223, filed on May 2, 2001.

(51) Int. Cl. B65D 6/00; B65D 8/00; B60P 3/00

(52) U.S. Cl. 220/562; 220/4.14

(57) ABSTRACT

A fuel tank assembly comprises a fuel tank having a wall with an outer surface and an inner surface, an elongated single or multi-walled tubular body having a first open end and a second open end, the first open end extending outwardly through an opening in the tank wall, and the second open end extending inwardly into the tank and bonded to the tank wall along the periphery of the tank wall opening by an adhesive which bonds to low surface energy plastic materials, the adhesive providing a fuel vapor-tight seal at the interface between the tubular body and tank wall opening, the fuel tank and the tubular body having fuel barrier property.

This application claims the benefit of U.S. Provisional Application No. 60/288,223, filed May 2, 2001.

### BACKGROUND OF THE INVENTION

The present invention relates to plastic fuel tanks and fuel transport lines.

Currently, the attachments of fuel transport lines to fuel tanks are an area of concern due to cost of the assembly and the excessive emissions of fuel vapor into the atmosphere.

Plastic fuel tanks for automobiles are commonly produced by blow molding process, such as extrusion blow molding, that is, by extruding a parison into an open mold, closing the mold and blow molding the parison. Extrusion blow molding is a well known process. See, for example, H. G. Fritz “Extrusion Blow Molding,” Plastics Extrusion Technology, Edited by Friedhelm Hensen, Hanser Publishers, pp.363-427.

Plastic fuel tanks can also be made by forming or casting a single unit or can be made by joining two or more sections into a finished unit. Further, the tanks can be formed having ports for sensor installation and for fuel inlet tubes.

Plastic fuel tanks currently use injection molded high density polyethylene (HDPE) nipples that are hot plate welded or spun-welded to the outer tank wall. A single or multi-walled tube is forced-fit over the nipple and fastened with a mechanical fastener, i.e. steel strap. The outer end of the tube has, or may have, a quick release fitting that attaches to the steel or polymer tubing that transports the fuel to the engine compartment. The injection molded nipple does not have fuel barrier property and, therefore, fuel vapors can permeate through the nipples. In addition, fuel vapor can be lost through the interface between the single or multi-walled tube, the nipple, and the outer wall of the tank.

It would be desirable to provide an assembly of a fuel tank and fuel transport lines which do not release fuel vapors to the environment.

### SUMMARY OF THE INVENTION

In a first aspect, the present invention is a fuel tank assembly comprising a fuel tank having a wall with an outer surface and an inner surface, an elongated single or multi-walled tubular body having a first open end and a second open end, the first open end extending outwardly through an opening in the tank wall, and the second open end extending inwardly into the tank and bonded to the tank wall along the periphery of the tank wall opening by an adhesive with some barrier properties, the adhesive providing a fuel vapor-tight seal at the interface between the tubular body and tank wall opening, the fuel tank and the tubular body comprising a polymer having fuel barrier property.

In a second aspect, the present invention is a fuel tank assembly comprising a fuel tank having a wall with an outer surface and an inner surface, a fuel transport line having a first open end and a second open end, the first open end extending outwardly through an opening in the tank wall, and the second open end extending inwardly into the tank and bonded to the tank wall along the periphery of the tank wall opening by an adhesive with some barrier properties, the adhesive providing a fuel vapor-tight seal at the interface between the fuel transport line and tank wall opening, the fuel tank and the fuel transport line comprising a polymer having fuel barrier property.

### BRIEF DESCRIPTION OF THE ACCOMPANYING DRAWING

FIG. 1 is a cross sectional view of a single or multi-walled tubular body which is adapted to be bonded to a conventional plastic fuel tank.

FIG. 2 is a cross sectional view of an alternative embodiment of the single or multi-walled tubular body shown in FIG. 1.

FIG. 3 is a cross sectional view of an assembly comprising the single or multi-walled tubular body shown in FIG. 1 bonded to the inside surface of a fuel tank.

FIG. 4 is a cross sectional view of an assembly comprising a fuel transport line bonded to the inside surface of a fuel tank.

### DETAILED DESCRIPTION OF THE INVENTION

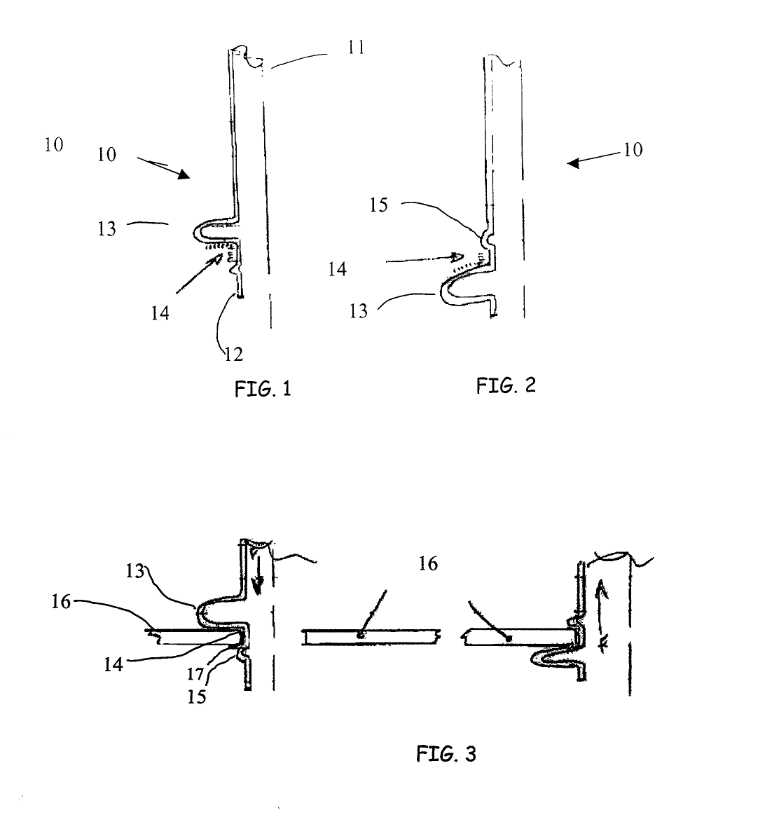

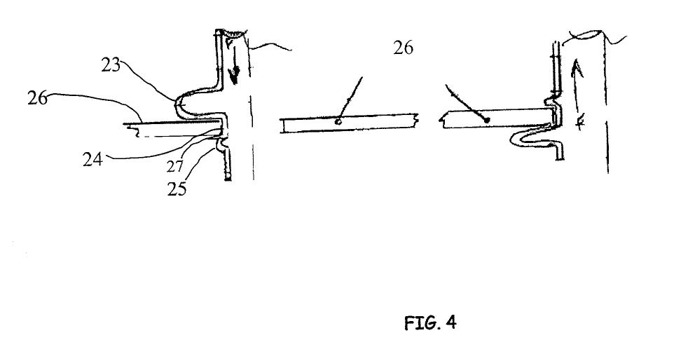

Referring to FIGS. 1, 2 and 3, there is shown a single or multi-walled tubular body 10 with a first end 11 and a second end 12. Spaced from second end 12 is a radially and outwardly extending fluted surface 13 and a raised surface 15. Extending from one side of fluted surface 13 to the nearest side of raised surface 15 is bondline 14.

In operation, tubular body 10 is pushed into (FIG. 1) or pulled through the fuel tank (FIG. 2) through a hole cut out of the wall. Fluted surface 13 and raised surface 15 snap fit over tank wall 16. As shown, tubular body 10 is attached to tank wall 14 through fluted surface 13 which is bonded to tank wall 16 along bondline 14 by means of adhesive 17. Raised surface 15 holds tubular body 10 until adhesive 17 is cured to an acceptable green strength. Either bondline 14 or fluted surface 13 is coated with adhesive 17. Adhesive 17 provides a fuel vapor-tight bond between tubular body 10 and tank wall 16. A quick connect may be added to the end of the tubular body outside the tank. Quick connects are well known in the art, and are described, for example in U.S. Pat. No. 5,310,226.

Referring now to FIG. 4, the “tank end” of fuel transport lines such as vent lines, fuel line and return line, is provided with a radially and outwardly extending fluted surface 23 and raised surface 25. Extending from one side of fluted surface 23 to the nearest side of raised surface 25 is bondline 24.

As used herein, the term “tank end” refers to the end of the vent lines, fuel line and return line which is attached to the fuel tank.

To attach the fuel transport lines to a fuel tank, each of the tank end of these lines is press-fit or pulled through into drilled or pre-drilled holes in the tank until the fluted surface 23 and raised surface 25 snap fit over tank wall 26. Fluted surface 23 is bonded to tank wall 26 along bondline 24 by means of adhesive 27. The fuel tank is then moved to the next assembly cell or to a curing area.

In general, the fuel transport lines are produced by extrusion, or injection molding, which is known in the art. See, for example, U.S. Pat. Nos. 6,190,154 and 6,204,312. The fluted end may be added via compression molding or through mandrel forming operations during a secondary operation.

Preferably, the plastic fuel tank, the multi-walled tubular body and the fuel transport lines comprise a multilayer laminate structure having one or more layers of a low energy surface material and one or more layers of a polymer having fuel barrier property.

More preferably, the plastic fuel tank, the multi-walled tubular body and the fuel transport lines comprise a three-layer laminate structure having two outer layers of a low energy surface material and a core layer of a polymer having fuel barrier property.

The low energy surface materials which can be employed in the practice of the present invention include polyolefins such as polyethylene and polypropylene and polytetrafluoroethylene (PTFE).

Polyolefins which can be employed in the practice of the present invention for preparing the multilayer laminate structure include polypropylene, polyethylene, and copolymers and blends thereof, as well as ethylene-propylene-diene terpolymers.

Preferred polyolefins are polypropylene, linear high density polyethylene (HDPE), heterogeneously-branched linear low density polyethylene (LLDPE) such as DOWLEX™ polyethylene resin (a Trademark of The Dow Chemical Company), heterogeneously branched ultra low linear density polyethylene (ULDPE) such as ATTANE™ ULDPE (a Trademark of The Dow Chemical Company); homogeneously-branched, linear ethylene/α-olefin copolymers such as TAFMER™ (a Trademark of Mitsui Petrochemicals Company Limited) and EXACT™ (a Trademark of Exxon Chemical Company); homogeneously branched, substantially linear ethylene/α-olefin polymers such as AFFINITY™ (a Trademark of The Dow Chemical Company) and ENGAGE® (a Trademark DuPont Dow Elastomers L.L.C.) of polyolefin elastomers, which can be prepared as disclosed in U.S. Pat. Nos. 5,272,236 and 5,278,272; and high pressure, free radical polymerized ethylene polymers and copolymers such as low density polyethylene (LDPE), ethylene-acrylic acid (EAA) copolymers such as PRIMACOR™ (Trademark of The Dow Chemical Company), and ethylene-vinyl acetate (EVA) copolymers such as ESCORENE™ polymers (a Trademark of Exxon Chemical Company), and ELVAX™ (a Trademark of E. I. du Pont de Nemours & Co.). The more preferred polyolefins are the homogeneously-branched linear and substantially linear ethylene copolymers with a density (measured in accordance with ASTM D-792) of 0.85 to 0.99 g/cm³, a weight average molecular weight to number average molecular weight ratio (Mw/Mn) from 1.5 to 3.0, a measured melt index (measured in accordance with ASTM D-1238 (190/2.16)) of 0.01 to 100 g/10 min, and an I10/I2 of 6 to 20 (measured in accordance with ASTM D-1238 (190/10)).

The most preferred polyolefin is a high density polyethylene. In general, high density polyethylene (HDPE) has a density of at least about 0.94 grams per cubic centimeter (g/cc) (ASTM Test Method D-1505). HDPE is commonly produced using techniques similar to the preparation of linear low density polyethylenes. Such techniques are described in U.S. Pat. Nos. 2,825,721; 2,993,876; 3,250,825 and 4,204,050. The preferred HDPE employed in the practice of the present invention has a density of from 0.94 to 0.99 g/cc and a melt index of from 0.01 to 35 grams per 10 minutes as determined by ASTM Test Method D-1238.

Polymers having fuel barrier property which can be employed in the practice of the present invention for preparing the plastic fuel tank and the multi-walled tubular body include polyamides, polyetrafluroethylene (PTFE), polyamides, fluoroelastomers, polyacetal homopolymers and copolymers, sulfonated and fluorinated HDPE, ethylene vinyl alcohol polymers and copolymers, hydroxy-functionalized polyethers and polyesters, and branched polyesters.

Specific examples of polyamides include nylon 6, nylon 66, nylon 610, nylon 9, nylon 11, nylon 12, nylon 6/66, nylon 66/610, and nylon 6/11.

The single-wall tubular body which is bonded to the tank wall comprises a plastic material, such as polyethylene (also multi wall HDPE extrusions with EvoH barrier), nylon, polyester, or fluoroelastomers, or a metal material, such as steel and aluminum.

The tie layer, also commonly referred to as an adhesive layer, which can be employed in the practice of the present invention for preparing the multilayer structure is made of an adhesive material, such as a modified polyethylene elastomer. Preferably, the adhesive material is a maleic anhydride grafted polyethylene or polypropylene such as ADMER™ (Trademark of Mitsui Petrochemicals) adhesive resin or ethylene-vinyl acetate copolymer resins such as ELVAX™ (Trademark of DuPont).

The adhesives which can be employed in the practice of the present invention for attaching the fuel transport lines to the fuel tank include those adhesives which bond to low energy surface plastic materials, such as the adhesive commercially known as LEA and described in an advertisement in the SPE Plastics Engineering magazine, March 2001 page 22; and adhesives comprising an amine/organoborane complex, such as those described in a series of patents issued to Skoultchi (U.S. Pat. Nos. 5,106,928, 5,143,884, 5,286,821, 5,310,835 and 5,376,746), incorporated herein by reference. These patents disclose a two-part initiator system that is reportedly useful in acrylic adhesive compositions. The first part of the two-part system includes a stable organoborane/amine complex and the second part includes a destabilizer or activator such as an organic acid or an aldehyde. The organoborane compound of the complex has three ligands which can be selected from C₁₋₁₀ alkyl groups or phenyl groups. Useful amines disclosed include octylamine, 1,6-diaminohexane, diethylamine, dibutylamine, diethylenetriamine, dipropylenediamine, 1,3-propylenediamine, and 1,2-propylenediamine.

Other adhesives which can be employed in the practice of the present invention for attaching plastic components to fuel tanks include those adhesives disclosed by Zharov et al. in a series of U.S. patents (U.S. Pat. No. 5,539,070; U.S. Pat. No. 5,690,780; and U.S. Pat. No. 5,691,065), incorporated herein by reference. These patents describe polymerizable acrylic compositions which are particularly useful as adhesives wherein organoborane/amine complexes are used to initiate cure. The organoboranes used have three ligands attached to the borane atom which are selected from C₁₋₁₀ alkyl groups and phenyl. The amine is an alkanol amine or a diamine where the first amine group can be a primary or secondary amine and the second amine is a primary amine. It is disclosed that these complexes are good for initiating polymerization of an adhesive which bonds to low surface energy substrates.

Pocius in a series of patents (U.S. Pat. No. 5,616,796; U.S. Pat. No. 5,6211,43; U.S. Pat. No. 5,681,910; U.S. Pat. No. 5,686,544; U.S. Pat. No. 5,718,977; and U.S. Pat. No. 5,795,657), all of which are incorporated herein by reference discloses amine/organoborane complexes with a variety of amines such as polyoxyalkylene polyamines and polyamines which are the reaction product of diprimary amines and compound having at least two groups which react with a primary amine.

The most preferred adhesive which can be employed in the practice of the present invention for attaching the fuel transport lines to the fuel tank is a class of preferred amines described in copending application U.S. Ser. No. 09/466,321, filed Dec. 17, 1999, incorporated herein by reference. These preferred amines comprise an amine/organoborane complex wherein the organoborane is a trialkyl borane or alkyl cycloalkyl borane and the amine is selected from the group consisting of (1) amines having an amidine structural component; (2) aliphatic heterocycles having at least one nitrogen in the heterocyclic ring, wherein the heterocycles may also contain one or more nitrogen atoms, oxygen atoms, sulfur atoms, or double bonds; (3) primary amines which, in addition, have one or more hydrogen bond accepting groups wherein there are at least two carbon atoms between the primary amine and the hydrogen bond accepting group, such that due to inter- or intramolecular interactions within the complex, the strength of the B—N bond is increased; and (4) conjugated imines.

Preferably, the trialkyl borane or alkyl cycloalkyl borane corresponds to Formula 1:

B(R²)3 Formula 1

wherein B represents Boron; and R² is separately in each occurrence a C₁₋₁₀ alkyl, C₃₋₁₀ cycloalkyl, or two or more of R² may combine to form a cycloaliphatic ring. Preferably R² is C₁₋₄ alkyl, even more preferably C₂₋₄ alkyl, and most preferably C₃₋₄ alkyl.

The amine comprises a compound having a primary amine and one or more hydrogen bond accepting groups, wherein there are at least two carbon atoms, preferably at least about three, between the primary amine and hydrogen bond accepting groups. Hydrogen bond accepting group means herein a functional group that through either inter- or intramolecular interaction with a hydrogen of the borane-complexing amine increases the electron density of the nitrogen of the amine group complexing with the borane. Preferred hydrogen bond accepting groups include primary amines, secondary amines, tertiary amines, ethers, halogen, polyethers, and polyamines.

Preferably, the amine corresponds to Formula 2:

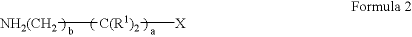

wherein:

R¹ is separately in each occurrence hydrogen or a C₁₋₁₀ alkyl or C₃₋₁₀ cycloalkyl;

X is hydrogen bond accepting moiety; a is an integer of 1 to 10; and b is separately in each occurrence an integer of 0 to 1, and the sum of a and b is from 2 to 10. Preferably R¹ is hydrogen or methyl. Preferably X is separately in each occurrence a hydrogen accepting moiety with the proviso that when the hydrogen accepting, moiety is an amine it is a tertiary or a secondary amine. More preferably X is separately in each occurrence —N(R⁸)ₑ, —OR¹⁰, or a halogen wherein R⁸ is separately in each occurrence C₁₋₁₀ alkyl, C₃₋₁₀ cycloalkyl or —(C(R¹)₂)_{d}—W; R¹⁰ is separately in each occurrence, C₁₋₁₀ alkyl, C₃₋₁₀ cycloalkyl, or —(C(R¹)₂)_{d}—W; and e is 0, 1, or 2. More preferably X is —N(R⁸)₂ or —OR¹⁰. Preferably, R⁸ and R¹⁰ are C₁₋₄ alkyl or —(C(R¹)₂)_{d}—W, more preferably C₁₋₄ alkyl and most preferably methyl. W is separately in each occurrence hydrogen or C₁₋₁₀ alkyl or X and more preferably hydrogen or C₁₋₄ alkyl. Preferably, a is about 1 or greater and more preferably 2 or greater. Preferably a is about 6 or less, and most preferably about 4 or less. Preferably, b is about 1. Preferably, the sum of a and b is an integer about 2 or greater and most preferably about 3 or greater. Preferably the sum of a and b are about 6 or less and more preferably about 4 or less. Preferably d is separately in each occurrence an integer of 1 to 4, more preferably 2 to 4, and most preferably 2 to 3. Among preferred amines corresponding to Formula 2 are dimethylaminopropyl amine, methoxypropyl amine, dimethylaminoethylamine, dimethylaminobutylamine, methoxybutyl amine, methoxyethyl amine, ethoxypropylamine, propoxypropylamine, amine terminated polyalkylene ethers (such as trimethylolpropane tris(poly(propyleneglycol), amine-terminated)ether), aminopropylmorpholine, isophoronediamine, and aminopropylpropanediamine.

In one embodiment the preferred amine complex corresponds to Formula 3:

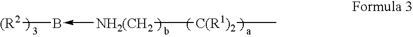

wherein R¹, R², X, a and b are as defined hereinbefore.

In another embodiment the amine is an aliphatic heterocycle having at least one nitrogen in the heterocycle. The heterocyclic compound may also contain one or more of nitrogen, oxygen, sulfur or double bonds.

In addition, the heterocycle may comprise multiple rings wherein at least one of the rings has a nitrogen in the ring. Preferably the aliphatic heterocylic amine corresponds to Formula 4:

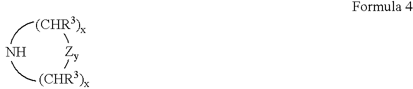

wherein:

R³ is separately in each occurrence hydrogen, a C₁₋₁₀ alkyl or C₃₋₁₀ cycloalkyl;

Z is separately in each occurrence oxygen or NR⁴ wherein R⁴ is hydrogen, C₁₋₁₀ alkyl, or C₆₋₁₀ aryl or alkaryl;

x is separately in each occurrence an integer of 1 to 10, with the proviso that the total of all occurrences of x should be from 2 to 10; and y is separately in each occurrence 0 or 1. Preferably, R³ is separately in each occurrence hydrogen or methyl. Preferably Z is NR⁴. Preferably, R⁴ is hydrogen or C₁₋₄ alkyl, and more preferably hydrogen or methyl. Preferably x is from 1 to 5 and the total of all the occurrences of x is 3 to 5. Preferred compounds corresponding to Formula 4 include morpholine, piperidine, pyrolidine, piperazine, 1,3,3-trimethyl 6-azabicyclo[3.2.1]octane, thiazolidine, homopiperazine, aziridine, 1,4-diazabicylo[2.2.2]octane (DABCO), 1-amino-4-methylpiperazine, and 3-pyrroline. Complexes using aliphatic heterocyclic amines preferably correspond to Formula 5:

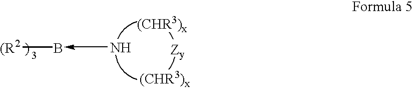

wherein R², R³, Z, x and y are as defined hereinbefore.

In yet another embodiment, the amine which is complexed with the organoborane is an amidine. Any compound with amidine structure wherein the amidine has sufficient binding energy as described hereinbefore with the organoborane, may be used. Preferable amidine compounds correspond to Formula 6:

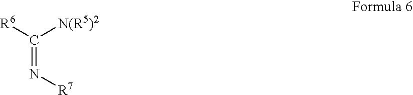

wherein:

R⁵, R⁶, and R⁷ are separately in each occurrence hydrogen, a C₁₋₁₀ alkyl or C₃₋₁₀ cycloalkyl; two or more of R⁵, R⁶, and R⁷ may combine in any combination to form a ring structure, which may have one or more rings. Preferably R⁵, R⁶ and R⁷ are separately in each occurrence hydrogen, C₁₋₄ alkyl or C₅₋₆ cycloalkyl. Most preferably R⁷ is H or methyl. In the embodiment where two or more of R⁵, R⁶ and R⁷ combine to form a ring structure the ring structure is preferably a single or a double ring structure. Among preferred amidines are 1,8-diazabicyclo[5,4]undec-7-ene; tetrahydropyrimidine; 2-methyl-2-imidazoline; and 1,1,3,3-tetramethylguanidine.

The organoborane amidine complexes preferably correspond to Formula 7:

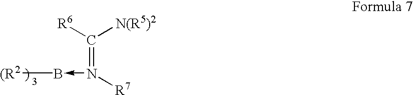

wherein R², R⁵, R⁶ and R ⁷ are as defined earlier.

In yet another embodiment, the amine which is complexed with the organoborane is a conjugated imine. Any compound with a conjugated imine structure, wherein the imine has sufficient binding energy as described hereinbefore with the organoborane, may be used. The conjugated imine can be a straight- or branched-chain imine or a cyclic imine. Preferable imine compounds correspond to Formula 8:

NR⁷═CR⁹—(CR⁹═CR⁹)_{c}—Y Formula 8

wherein Y is independently in each occurrence hydrogen, N(R⁴)₂, OR⁴, C(O)OR⁴, halogen or an alkylene group which forms a cyclic ring with an R⁷ or R⁹. R⁴ is hydrogen, C₁₋₁₀ alkyl, or C₆₋₁₀ aryl or alkaryl. Preferably R⁴ is hydrogen or methyl. R⁷ is as described previously. R⁹ is independently in each occurrence hydrogen, Y, C₁₋₁₀ alkyl, C₃₋₁₀ cycloalkyl-, (C(R¹)₂—(CR⁹═CR⁹)_{c}—Y or two or more of R⁹ can combine to form a ring structure provided the ring structure is conjugated with respect to the double bond of the imine nitrogen; and c is an integer of from 1 to 10. Preferably, R⁹ is hydrogen or methyl.

Y is preferably N(R⁴ )₂, or OR⁴, or an alkylene group which forms a cyclic ring with R⁷ or R⁹. Y is more preferably N(R⁴)₂ or an alkylene group which forms a cyclic ring with R⁷ or R⁹. Preferably, c is an integer of from 1 to 5, and most preferably about 1. Among preferred conjugated imines useful in this invention are 4-dimethylaminopyridine; 2,3-bis(dimethylamino)cyclopropeneimine; 3-(dimethylamine)acroleinimine; 3-(dimethylamino)methacroleinimine.

Among preferred cyclic imines are those corresponding to the following structures

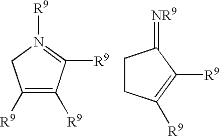

The complexes with the conjugated imines preferably correspond to Formula 9:

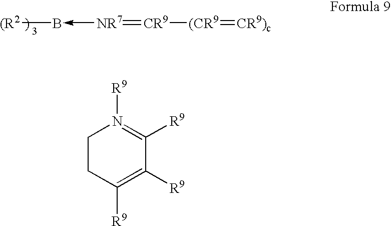

wherein R², R⁷, R⁹, c and Y are as defined hereinbefore.

The molar ratio of amine compound to borane compound in the complex is relatively important. In some complexes if the molar ratio of amine compound to organoborane compound is too low, the complex is pyrophoric. Preferably the molar ratio of amine compound to organoborane compound is from 1.0:1.0 to 3.0:1.0. Below the ratio of about 1.0:1.0 there may be problems with polymerization, stability of the complex and for adhesive uses, adhesion. Greater than about a 3.0:1.0 ratio may be used although there is no benefit from using a ratio greater than about 3.0:1.0. If too much amine is present, this may negatively impact the stability of the adhesive or polymer compositions. Preferably the molar ratio of amine compound to organoborane compound is from 2.0:1.0 to 1.0:1.0.

Polymerizable compounds which may be used in the polymerization compositions of the adhesive include acrylate and/or methacrylate based compounds, with methylmethacrylate, butylmethacrylate, 2-ethylhexylmethacrylate, isobornylmethacrylate, tetrahydrofurfuryl methacrylate, and cyclohexylmethylmethacrylate as the most preferred.

Each of the polymers forming the layers of the multilayer laminate structure of the present invention may contain various additives in an amount that does not adversely affect the desired properties of the polymers. Examples of such additives include antioxidants, ultraviolet light absorbers, thermal processing stabilizers, colorants, lubricants, flame retardants, impact modifiers, plasticizers, antistatic agents, pigments, and nucleating agents and fillers, such as zeolite, talc, and calcium carbonate. The method of incorporating the additives is not critical. The additives can conveniently be added to the polymer prior to preparing the multilayer laminate structure. If the polymer is prepared in solid form, the additives can be added to the melt prior to preparing the multilayer laminate structure.

What is claimed is:

1. A fuel tank assembly comprising a fuel tank having a wall with an outer surface and an inner surface, an elongated single or multi-walled tubular body having a first open end and a second open end, the first open end extending outwardly through an opening in the tank wall, and the second open end extending inwardly into the tank and bonded to the tank wall along the periphery of the tank wall opening by an adhesive which bonds to low surface energy plastic materials, the adhesive providing a fuel vapor-tight seal at the interface between the tubular body and tank wall opening, the fuel tank and the tubular body comprising a polymer having fuel barrier property.

2. The fuel tank assembly of claim 1 wherein the adhesive is an amine/organoborane complex.

3. The fuel tank assembly of claim 2 wherein the organoborane compound of the complex is a trialkyl borane or alkyl cycloalkyl borane and the amine compound is selected from the group consisting of (1) amines having an amidine structural component; (2) aliphatic heterocycles having at least one nitrogen in the heterocyclic ring, wherein the heterocyclic compound may also contain one or more nitrogen atoms, oxygen atoms, sulfur atoms, or double bonds in the heterocycle; (3) primary amines which, in addition, have one or more hydrogen bond accepting groups wherein there are at least two carbon atoms between the primary amine and the hydrogen bond accepting group, such that due to inter- or intramolecular interactions within the complex, the strength of the B—N bond is increased; and (4) conjugated imines.

4. The fuel tank assembly of claim 2 wherein the complex of the organoborane and the primary amine corresponds to the formula 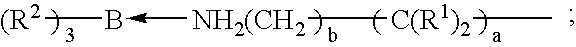
the organoborane heterocyclic amine complex corresponds to the formula 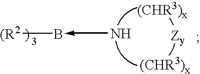
the organoborane amidine complex corresponds to the formula 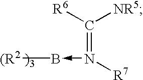
and the organoborane conjugated imine complex corresponds to the formula
(R²)₃B←NR⁷═CR⁹—(CR⁹═CR⁹)_{c};
wherein:
B is boron; R¹ is separately in each occurrence hydrogen, a C₁₋₁₀ alkyl or C₃₋₁₀ cycloalkyl;
R² is separately in each occurrence a C₁₋₁₀ alkyl, C₃₋₁₀ cycloalkyl or two or more of R² may combine to form a cycloaliphatic ring structure;
R³ is separately in each occurrence hydrogen, a C₁₋₁₀ alkyl or C₃₋₁₀ cycloalkyl; R⁴ is separately in each occurrence hydrogen, C₁₋₁₀ alkyl, C₃₋₁₀ cycloalkyl, C₆₋₁₀ aryl or alkaryl; R⁵, R⁶, and R⁷ are separately in each occurrence hydrogen, C₁₋₁₀ alkyl, C₃₋₁₀ cycloalkyl, or two or more of R⁵, R⁶ and R⁷ in any combination can combine to form a ring structure which can be a single ring or a multiple ring structure and the ring structure can include one or more of nitrogen, oxygen or unsaturation in the ring structure; R⁹ is independently in each occurrence hydrogen, C₁₋₁₀ alkyl or C₃₋₁₀ cycloalkyl, Y, —(C(R⁹)₂—(CR⁹═CR⁹)_{c}—Y or two or more of R⁹ can combine to form a ring structure, or one or more of R⁹ can form a ring structure with Y provided the ring structure is conjugated with respect to the double bond of the imine nitrogen; X is a hydrogen-bond accepting group with the proviso that where the hydrogen bond accepting group is an amine it must be secondary or tertiary;
Y is independently in each occurrence hydrogen, N(R⁴)₂, OR⁴, C(O)OR⁴, a halogen or an alkylene group which forms a cyclic ring with R⁷ or R⁹; Z is separately in each occurrence oxygen or —NR⁴; a is separately in each occurrence an integer of from 1 to 10; b is separately in each occurrence 0 or 1, with the proviso that the sum of a and b should be from 2 to 10; c is separately in each occurrence an integer of from 1 to 10; x is separately in each occurrence an integer of 1 to 10, with the proviso that the total of all occurrences of x is from 2 to 10; and y is separately in each occurrence 0 or 1.

5. The fuel tank assembly of claim 2 wherein the organo borane/amine complex comprises an aliphatic heterocylic amine which is a five or six-membered heterocylic compound.

6. The fuel tank assembly of claim 2 wherein the organo borane compound of the complex has three ligands selected from C₁₋₁₀ alkyl groups or phenyl groups, and the amine compound is selected from 1,6-diaminohexane, diethylamine, dibutylamine, diethylenetriamine, dipropylenediamine, 1,3-propylenediamine, and 1,2-propylene-diamine.

7. The fuel tank assembly of claim 2 wherein the organoborane compound of the complex has three ligands attached to the borane atom and which are selected from C₁₋₁₀ alkyl groups and phenyl and the amine compound is an alkanol amine or a diamine wherein the first amine group is a primary or secondary amine and the second amine is a primary amine.

8. The fuel tank assembly of claim 2 wherein the amine compound of the complex is a polyoxyalkylene polyamine or a polyamine which is the reaction product of a diprimary amine and a compound having at least two groups which react with a primary amine.

9. The fuel tank assembly of claim 1 wherein the low surface energy plastic material is a polyolefin.

10. The fuel tank assembly of claim 9 wherein the polyolefin is selected from the group consisting of polyethylene, polypropylene and polytetrafluoroethylene.

11. The fuel tank assembly of claim 1 wherein the polymer having fuel barrier property is selected from the group consisting of polyamides, fluoroelastomers, polyacetal homopolymers and copolymers, sulfonated and fluorinated HDPE, ethylene vinyl alcohol polymers and copolymers, hydroxy-functionalized polyethers and polyesters, and branched polyesters.

12. The fuel tank assembly of claim 1 wherein the fuel tank is a three-layer laminate structure comprising two outer layers of a low energy surface material and a core layer of a polymer having fuel barrier property.

13. The fuel tank assembly of claim 12 wherein the low energy surface material is polyethylene and the polymer having fuel barrier property is selected from the group consisting of polyamides, fluoroelastomers, polyacetal homopolymers and copolymers, sulfonated and fluorinated HDPE, ethylene vinyl alcohol polymers and copolymers, hydroxy-functionalized polyethers and polyesters, and branched polyesters.

14. The fuel tank assembly of claim 1 wherein the tubular body has a first end and a second end, a radially and outwardly extending fluted surface and a raised surface spaced from the second end, and a bondline extending from one side of the fluted surface to the nearest side of the raised surface.

15. A fuel tank assembly comprising a fuel tank having a wall with an outer surface and an inner surface, a single or multi-walled fuel transport line having a first open end and a second open end, the first open end extending outwardly through an opening in the tank wall, and the second open end extending inwardly into the tank and bonded to the tank wall along the periphery of the tank wall opening by an adhesive which bonds to low surface energy plastic materials, the adhesive providing a fuel vapor-tight seal at the interface between the fuel transport line and tank wall opening, the fuel tank and the fuel transport line comprising a polymer having fuel barrier property.

16. The fuel tank assembly of claim 15 wherein the fuel transport line has a first end and a second end, a radially and outwardly extending fluted surface and a raised surface spaced from the second end, and a bondline extending from one side of the fluted surface to the nearest side of the raised surface.
